(19) United States
(12) Patent Application Publication
(10) Pub. No.: US 2006/0268118 A1
(43) Pub. Date: Nov. 30, 2006

(54) Digital photography device

(76) Inventor: Yueh-Shing Lee, Hsinfeng (TW)

Correspondence Address: LIN & ASSOCIATES INTELLECTUAL PROPERTY, P.O. BOX 2339, SARATOGA, CA, 95070-0339, US

(21) Appl. No.: 11/139,878

(22) Filed: May 27, 2005

(51) Int. Cl. H04N 5/228

(52) U.S. Cl. 348/222.1

(57) ABSTRACT

A digital photography device includes a lens module, an image memory module, an input/output port, an angle detecting module, an angle memory module connecting with the angle detecting module and an image processing module connecting with the lens module, the image memory module, the input/output port and the angle memory module. The angle detecting module detects an angle that the digital photography device is turned and processes the angle signal into angle data, and the angle data is inputted into the angle memory module. The image processing module controls the lens module to detect an image and processes the image into image data, and then the image data is inputted into the image memory module directly. When the image data is to be output through the input/output port, the image processing module reads the image data and the corresponding angle data and processes the image data according to the angle data, then outputs the processed image data through the input/output port.

### BACKGROUND OF THE INVENTION

1. Field of the Invention

The present invention generally relates to a digital photography device and, more particularly, to a digital photography device capable of detecting shooting angles.

2. The Related Art

At present, various kinds of digital photography devices, such as digital still camera and mobile telephone with the function of photography, are popular widely. In order to facilitate appreciating and store the photos that a user had taken, the user should equip a computer to store those photos and appreciates those photos on the monitor of the computer.

Because these digital photography devices have a small size and are easy to be turned, the user often turns the digital photography devices according to the scene to get an image which the user wants to get. As shown in FIG. 1, the digital photography device 10 is turned at 90 degree to take an image. However, when the image is stored in the computer, the monitor of the computer displays the image in traverse direction, as shown in FIG. 2. In order to fit the vision habit of the user, the image needs to be turn at 90 degree in clockwise by a manual means, which is inconvenient to the user.

In order to overcome the above shortcoming, a prior digital photography device 20 is disclosed in T.W. Patent No. 468330 issued on Dec. 11, 2001, as shown in FIG. 3. The digital photography device 20 includes a lens module 21, an image processing module 22, an angle detecting element 23, a memory module 24 and an input/output port 26. The angle detecting element 23 detects the shooting angle of the digital photography device 20. The image processing module 22 controls the lens module 21 to detect an image and processes the image into image data firstly, then the image processing module 22 processes the image data according to the angle signal that the angle detecting element 23 detects, at last, the processed image data is stored in the memory module 24 in a format fitting to the vision habit of the user. When the image data is output to an outer computer through the input/output port 26, the monitor of the computer displays the image in vertical direction directly, hence the user is not necessary to turn the image by manual means.

However, the course of taking an image is from the user pressing the shutter of the digital photography device 20 to the image data being stored in the memory module 24, in which the image processing module 22 needs to process the image data according to the angle signal that the angle detecting element 23 detects, as shown in FIG. 4. Therefore, the prior digital photography device 20 needs a long time to process the image when the digital photography device 20 is turned at an angle to take an image. Of course, the user can not take a next photo at once.

### SUMMARY OF THE INVENTION

An object of the present invention is to provide a digital photography device which can detect the shooting angle and shorten the time of taking an image when the photography device is turned at an angle to take an image.

To achieve the above object, the present invention provides a digital photography device which includes a lens module, an image memory module, an input/output port, an angle detecting module, an angle memory module and an image processing module. The angle detecting module detects an angle which the digital photography device is turned at to take an image, and then the angle detecting module processes the angle signal into angle data. The angle memory module connects with the angle detecting module for storing the angle data. The image processing module connects with the lens module, the image memory module, the input/output port and the angle memory module. The image processing module controls the lens module to detect an image and processes the image into image data, and then the image processing module inputs the image data into the image memory module directly. When the image data is to be output through the input/output port, the image processing module reads the image data from the image memory module and the corresponding angle data from the angle memory module, and the image processing module processes the image data according to the angle data and outputs the processed image data through the input/output port.

To achieve the above object, the present invention provides another digital photography device which includes a lens module, an image memory module, an input/output port, an angle detecting module, an angle memory module and an image processing module. The image processing module connects with the lens module and the image memory module. The image processing module controls the lens module to detect an image and processes the image into image data, and then the image processing module inputs the image data into the image memory module directly. The angle detecting module detects an angle which the digital photography device is turned at to take an image, and processes the angle signal into angle data. The angle memory module connects with the angle detecting module for storing the angle data. The input/output port connects with the image memory module and the angle memory module, through which the image data and the corresponding angle data are outputted.

As can be seen from the above description, the angle memory module is used to store angle data, and the image memory module is used to store image data directly. Therefore, the digital photography device is unnecessary to process the image data according to the angle signal immediately after the digital photography device takes an image every time. The image data is processed according to the angle data only when desired. As a result, the course of taking an image is shortened.

### BRIEF DESCRIPTION OF THE DRAWINGS

The present invention will be apparent to those skilled in the art by reading the following description of embodiments thereof, with reference to the attached drawings, in which:

FIG. 1 is a diagram of a prior digital photography device which is taking an image vertically;

FIG. 2 is a diagram illustrating the image shown in FIG. 1 being output and displayed on a monitor of an outer computer;

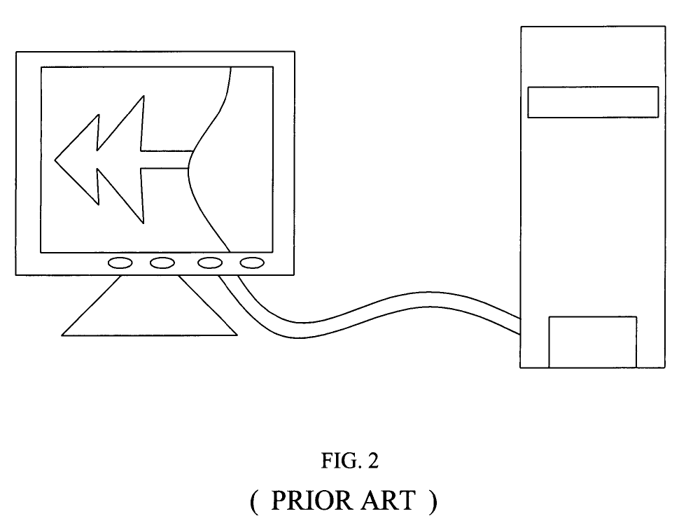

FIG. 3 is a block diagram of another prior digital photography device;

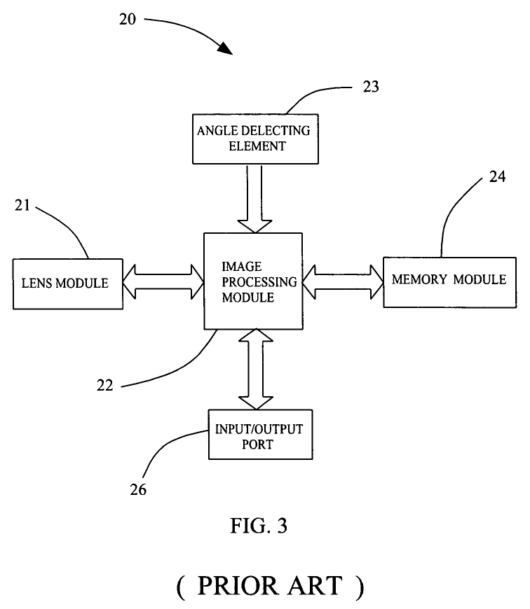

FIG. 4 is a flowchart of image procession of the digital photography device shown in FIG. 3;

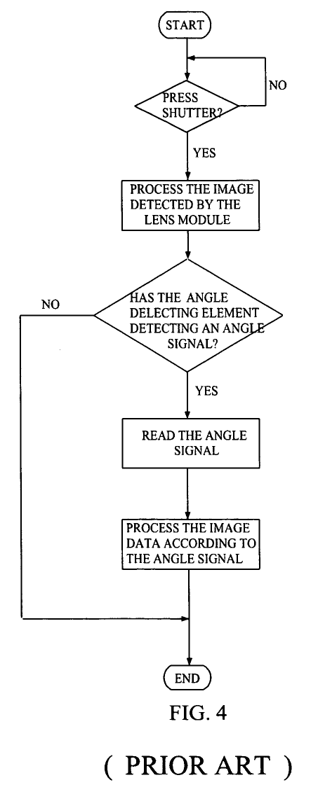

FIG. 5 is a block diagram of a first embodiment of a digital photography device according to the present invention;

FIG. 6 is a flowchart of image procession of the digital photography device shown in FIG. 5;

FIG. 7 is a flowchart of angle procession of the digital photography device shown in FIG. 5;

FIG. 8 is a flowchart of image data being outputted to an outer computer;

FIG. 9 is a flowchart of image data being outputted to a display module of the digital photography device shown in FIG. 5;

FIG. 10 is a diagram illustrating the image being displayed on the LCD of the digital photography device shown in FIG. 5;

FIG. 11 is a flowchart of image data being outputted to a display module of a digital photography device of a second embodiment according to the present invention;

FIG. 12 is a block diagram of a third embodiment of a digital photography device according to the present invention; and

FIG. 13 is a block diagram of a fourth embodiment of a digital photography device according to the present invention.

### DETAILED DESCRIPTION OF THE PREFERRED EMBODIMENTS

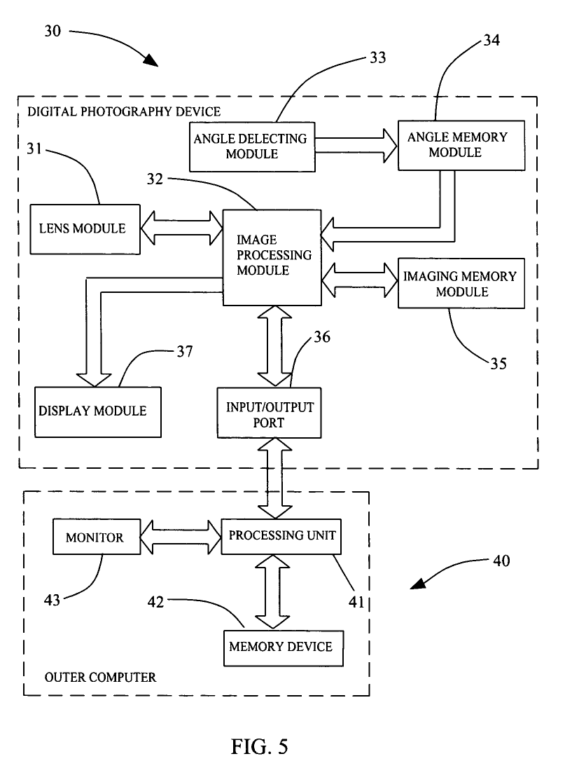

With reference to FIG. 5, a first embodiment of a digital photography device 30 according to the present invention is shown. In the present embodiment, the digital photography device 30 includes a lens module 31, an image processing module 32, an angle detecting module 33, an angle memory module 34, an image memory module 35, an input/output port 36 and a display module 37.

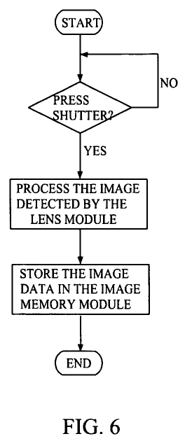

With reference to FIG. 5 and FIG. 6, the lens module 31 connects with the image processing module 32, which is used to detect an image of the outer scene under the control of the image processing module 32. The image processing module 32 processes the image into the image data and outputs the image data into the image memory module 35 directly which connects with the image processing module 32.

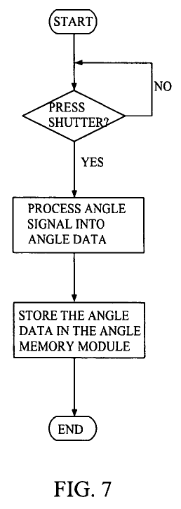

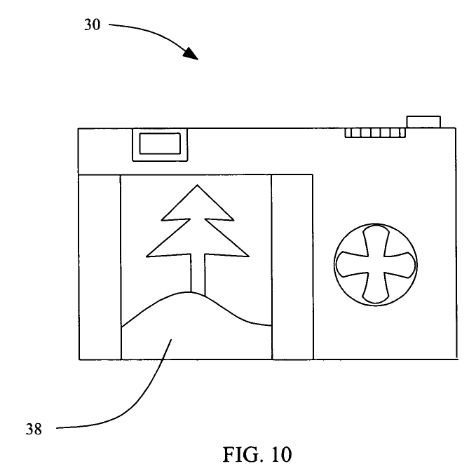

The angle detecting module 33 has an angle detecting element (not shown in drawings), and the angle detecting element can be a gravity sensor, which is used to detect the angle of the digital photography device 30 being tuned relative to the digital photography device 30 being disposed in parallel (as shown in FIG. 10). When the user presses the shutter, the angle detecting module 33 processes the angle signal which the angle detecting element detects into an angle data, and then the angle detecting module 33 outputs the angle data into the angle memory module 34 which connects with the angle detecting module 33, as shown in FIG. 7. For example, when the user takes the first image, the digital photography device 30 is set in parallel, that is the angle of the digital photography device 30 being tuned is 0 degree, the angle detecting module 33 processes the angle signal into the angle data 0 and outputs the angle data 0 into the angle memory module 34; when the user takes the second image, the angle is 90 degree, the angle detecting module 33 processes the angle signal into the angle data 1 and outputs the angle data 1 into the angle memory module 34; when the user takes the third image, the angle is 180 degree, the angle detecting module 33 processes the angle signal into the angle data 2 and outputs the angle data 2 into the angle memory module 34; when the user takes the fourth image, the angle is 270 degree, the angle detecting module 33 processes the angle signal into the angle data 3 and outputs the angle data 3 into the angle memory module 34.

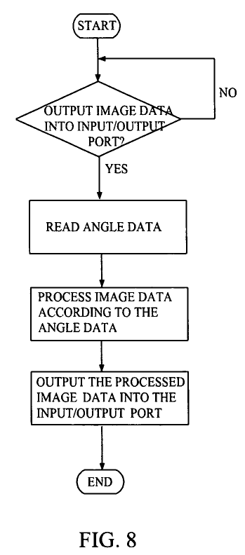

With reference to FIG. 5 and FIG. 8, the angle memory module 34 further connects with the image processing module 32. When the image data is inputted into an outer computer 40, the image processing module 32 reads the angle data from the angle memory module 34, then the image processing module 32 reads the image data from the image memory module 35 and processes the image data according to the corresponding angle data, and at last the image processing module 32 outputs the processed image data into the outer computer 40 through the input/output port 36.

The outer computer 40 stores the processed image data in the memory device 41 under control of the processing unit 42. When the user appreciates the image on the monitor 43, the image is displayed on the monitor 43 by means of fitting the vision habit of the user directly. Therefore the user is not necessary to turn the image manually.

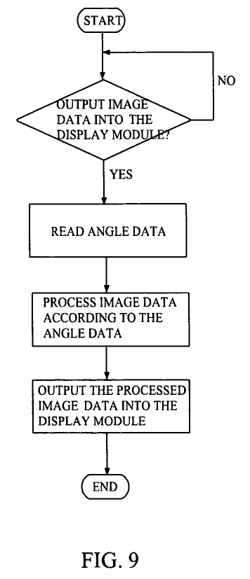

With reference to FIG. 5, FIG. 7 and FIG. 9, the display module 37 connects with the image processing module 32, and the display module 37 has a LCD 38. When the user wants to skim the image on the LCD 38, firstly, the image processing module 32 reads the angle data from the angle memory module 34; secondly, the image processing module 32 reads the image data from the image memory module 35 and processes the image data according to the corresponding angle data; and at last the image processing module 32 outputs the processed image data into the display module 37.

Furthermore, the angle memory module 34 and the image memory module 35 in the present embodiment can be formed by individual memory areas of a memory body, for example, a SD card is divided into two memory areas, one memory area is used to store angle data, and the other is used to store image data.

According to the mentioned above, the angle memory module 34 is used to store angle data, and the image memory module 35 is used to store image data directly. Therefore, the digital photography device 30 is unnecessary to process the image data according to the angle signal immediately after the digital photography device takes an image every time. The image data is processed according to the angle data only when desired. As a result, the course of taking an image is shortened.

However, when the user skims image on the LCD 38 of the display module 37 in the present embodiment, the image is also turned a corresponding angle and set in the central section of the LCD 38. Both border districts of the LCD 38 is blank, as shown in FIG. 10. Therefore, the area of the LCD 38 is not fully utilized, and this causes the size of the image displayed on the LCD 38 is small. As a result, it is inconvenient for the user to skim the image clearly.

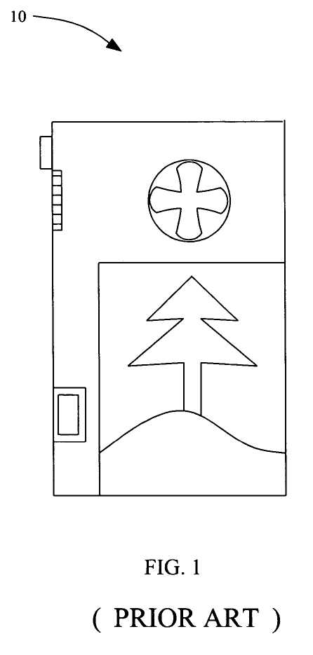

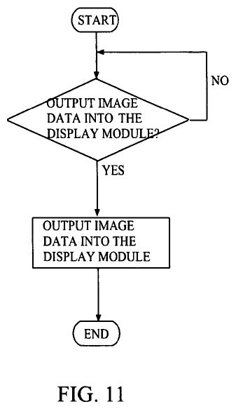

In order to overcome the above shortcoming, the second embodiment is provided, which has the same structure as the first embodiment. The difference between the present embodiment and the first embodiment is the procedure of the image being displayed on the LCD 38. In the present embodiment, the image processing module 32 reads the image data from the image memory module 35 and outputs the image data into the display module 37 directly, as shown in FIG. 11. Therefore the image is displayed on the LCD 38 at original angle (shown in FIG. 1), as a result, the area of the LCD 38 is fully utilized, and it is favorable for the user to skim the image clearly.

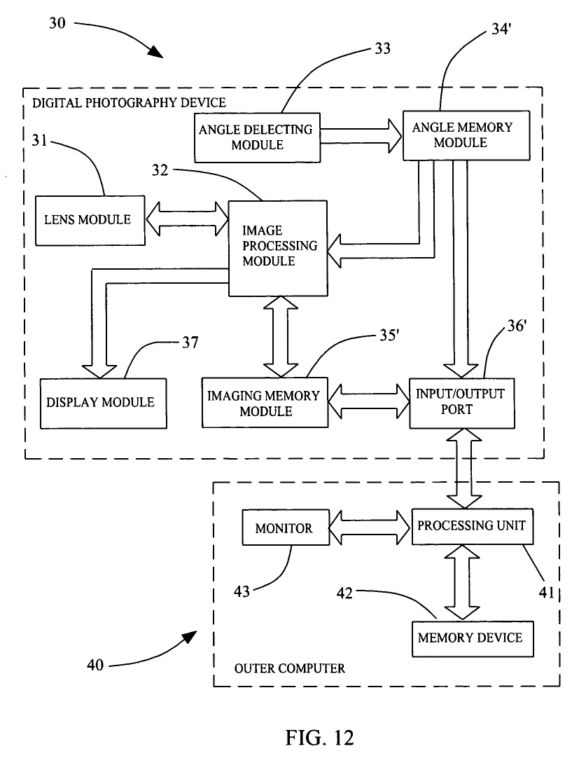

With reference to FIG. 12, a third embodiment of the digital photography device 30 is shown. The digital photography device 30 in the present embodiment is similar to that shown in the first embodiment. The difference is that the input/output port 36′ does not connect with the image processing module 32, but connects with the angle memory module 34′ and the image memory module 35′.

In the present embodiment, the outer computer 40 reads the image data from the image memory module 35′ and the corresponding angle data from the angle memory module 34′ through the input/output port 36′. The processing unit 42 of the outer computer 40 processes the image data according to the corresponding angle data, and then the processed image data is stored in the memory device 41 under the control of the processing unit 42. Therefore, when the user wants to appreciate the image on the monitor 43, the image is displayed according to the vision habit of the user directly.

When the image is displayed on the LCD 38, the procedure of the image process is same as that in the first embodiment. The image processing module 32 also reads the angle data from the angle memory module 34 firstly, then the image processing module 32 reads the image data from the image memory module 35 and processes the image data according to the angle data, and at last the image processing module 32 outputs the processed image data into the display module 37.

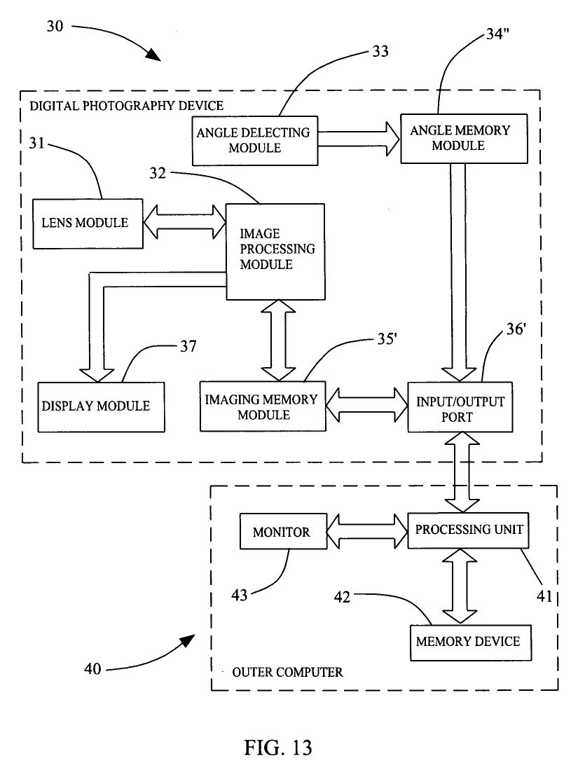

With reference to FIG. 13, a fourth embodiment of the digital photography device 30 is shown. The digital photography device 30 in the present embodiment is similar to that shown in the third embodiment. The difference is that the angle memory module 34″ does not connects with the image processing module 32 any more. When the user skims the image on the LCD 38, the image processing module 32 reads the image data from the image memory module 35″ and outputs the image data into the display module 37 directly. Therefore, the area of the LCD 38 is fully utilized, and it is favorable for the user to skim the image clearly.

Although the invention has been described above by reference to a certain embodiment of the invention, the invention is not limited to the embodiment described above. Modifications and variations of the embodiments described above will occur to those skilled in the art, in light of the above teachings.

What is claimed is:

1. A digital photography device, comprising:
a lens module;
an image memory module;
an input/output port;
an angle detecting module detecting an angle which the digital photography device is turned at to take an image, and processing the angle signal into angle data;
an angle memory module connecting with the angle detecting module for storing said angle data; and
an image processing module connecting with the lens module, the image memory module, the input/output port and the angle memory module, said image processing module controlling the lens module to detect an image and processing the image into image data and inputting said image data into the image memory module directly, when said image data is to be output through the input/output port, the image processing module reading said image data from the image memory module and the corresponding angle data from the angle memory module and processing said image data according to said angle data, then outputting the processed image data through the input/output port.

2. The digital photography device as claimed in claim 1, further comprising a display module, said display module connecting with the image processing module.

3. The digital photography device as claimed in claim 2, wherein when said image data is to be output to said display module, said image processing module reads said image data from the image memory module and outputs said image data to the display module directly.

4. The digital photography device as claimed in claim 2, wherein when said image data is to be output to said display module, said image processing module reads said image data from the image memory module and the corresponding angle data from the angle memory module and processes said image data according to the angle data, and then outputs the processed image data to the display module.

5. The digital photography device as claimed in claim 1, wherein the angle that the angle detecting module detects is 0 degree, 90 degree, 180 degree and 270 degree.

6. The digital photography device as claimed in claim 1, wherein said angle memory module and said image memory module are individual memory areas of a same memory body.

7. A digital photography device, comprising:
a lens module;
an image memory module;
an image processing module connecting with the lens module and the image memory module, said image processing module controlling the lens module to detect an image and processing the image into image data, said image data being inputted into the image memory module directly;
an angle detecting module detecting an angle which the digital photography device is turned at to take an image, and processing the angle signal into angle data;
an angle memory module connecting with the angle detecting module for storing said angle data; and
an input/output port connecting with the image memory module and the angle memory module, through which the image data and the corresponding angle data are outputted.

8. The digital photography device as claimed in claim 7, further comprising a display module, said display module connecting with the image processing module.

9. The digital photography device as claimed in claim 8, wherein the image processing module further connects with the angle memory module.

10. The digital photography device as claimed in claim 9, wherein when said image data is to be output to said display module, said image processing module reads said image data from the image memory module and the corresponding angle data from the angle memory module and processes said image data according to said angle data, and then outputs the processed image data to the display module.

11. The digital photography device as claimed in claim 7, wherein the angle that the angle detecting module detects is 0 degree, 90 degree, 180 degree and 270 degree.

12. The digital photography device as claimed in claim 7, wherein said angle memory module and said image memory module are individual memory areas of a same memory body.
